(19) United States
(12) Patent Application Publication
(10) Pub. No.: US 2024/0281150 A1
(43) Pub. Date: Aug. 22, 2024

(54) MEMORY READS BASED WITH A LIMITED RESPONSE TIME

(71) Applicant: Intel Corporation, Santa Clara, CA (US)

(72) Inventors: Yi ZENG, Shanghai (CN); Kaushik BALASUBRAMANIAN, Beaverton, OR (US); Eti BAYEVSKY, Givat Ze’ev (IL); Yuli BARCOHEN, Nokdim (IL); Lukasz GOLAWSKI, Gdynia (PL); Yaniv NISSIM, Jerusalem (IL)

(21) Appl. No.: 18/650,966

(22) Filed: Apr. 30, 2024

(30) Foreign Application Priority Data
Dec. 16, 2023 (WO) PCT/CN/2023139317

(51) Int. Cl. G06F 3/06

(52) U.S. Cl. CPC G06F 3/0619; G06F 3/0659; G06F 3/0679

(57) ABSTRACT

Examples described herein relate to an interface to a serial connection and circuitry to: prior to issuance of a read request to a device, issue a command to the device to identify data to be requested to be read and based on an indicator that the identified data is available to be read, send the read request for the identified data via the interface to the device. The command can include an operational code, a starting address, and length.

### RELATED APPLICATION

This application claims the benefit of priority to Patent Cooperation Treaty (PCT) Application No. PCT/CN2023/139317, filed Dec. 16, 2023. The entire content of that application is incorporated by reference in its entirety.

### BACKGROUND

Computer systems include central processing units (CPUs) that execute instructions to perform data processing operations. After a computer system is powered on, a CPU loads and executes Basic Input/Output System (BIOS) and configuration information from flash memory. The executed-BIOS manages data flow between the computer's operating system (OS) and devices, such as a memory device or a network interface device.

FIG. 1 depicts a prior art example of communications based on Serial Peripheral Interface (SPI)™. An interface consistent with SPI™ can be used to access BIOS from a flash memory. Signal SI is an input from a requester device to a memory device to read data. Signal SO is an output from the memory device to the requester device. If data is not stored in the memory device and is instead retrieved from another device, the memory device outputs dummy data from SO. However, SPI™ requires read operations to complete within a limited number of clock cycles.

### BRIEF DESCRIPTION OF THE DRAWINGS

FIG. 1 depicts an example prior art signals.

FIG. 2A depicts an example system.

FIGS. 2B and 2C depict an example operation.

FIGS. 3A and 3B depict example sequences.

FIG. 4 depicts an example process.

FIG. 5 depicts an example system.

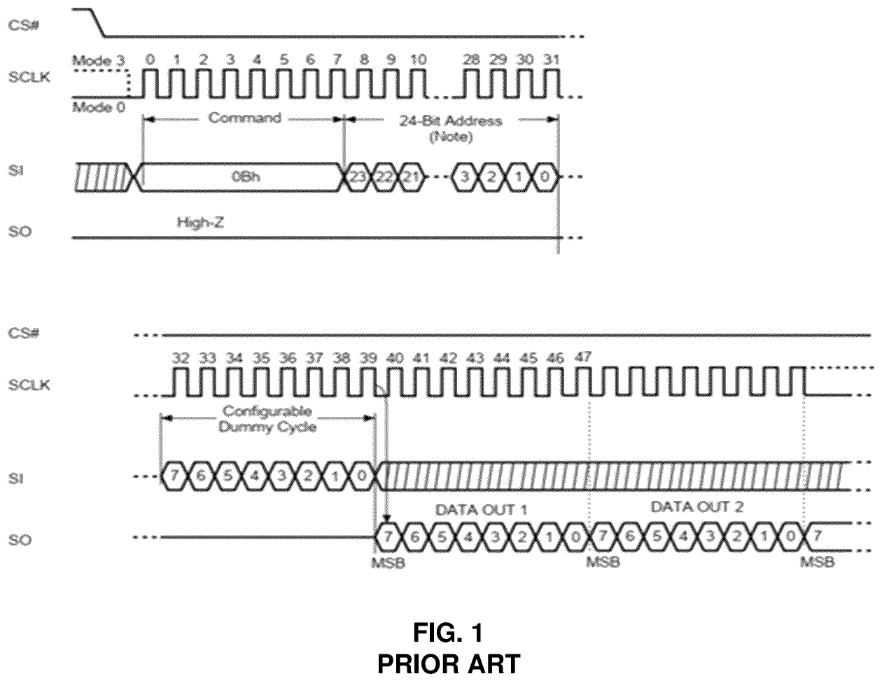

### DETAILED DESCRIPTION

Some architectures can access an accelerator (e.g., cryptographic security chip that performs data encryption and decryption, application specific integrated circuit (ASIC), Field Programmable Gate Array (FPGA), or other circuitry) via a SPI-consistent interface using flash device emulation. Due to an internal buffer size limit of the accelerator, data may not be stored entirely in the buffer of the accelerator. In a case of where data is stored outside of the buffer, in another memory device, the accelerator can fetch data from the another memory device. Where a read request is to be completed within a limited number of clock cycles (e.g., SPI Flash Read Timing associated with a SPI Wait State or dummy cycles), due to delay of data retrieval, the data may not be read within the limited number of clock cycles.

Various examples can permit utilization of interfaces to access data from a device (e.g., accelerator, processor, memory device, or other circuitry) that retrieves data from another device (e.g., off-chip storage, flash device, or emulated flash device) and provides data to be read within a limited number of clock cycles. Various examples can provide for a read operation in three phases. In Phase 1, a requester device can send a Read Request Command to the target device to identify a memory address and byte size to retrieve, but the Read Request Command can include a hint or indicator that the data is subsequently to be requested to be read, and not in this Read Request Command. In Phase 2, the requester device can poll for a busy status indicator from the target device to determine if the busy status indicator is cleared or timed out to identify a “wait state.” The target device can indicate that the target device has to fetch data from another device (e.g., local memory, remote memory, or other) by indicating a busy status. After the requested data is stored in the memory of the target device, the target device can read the requested data and de-assert the busy status. When busy status is de-asserted, the requester device can determine that data is available to read. In Phase 3, the requester device can issue a Read Request Command to the target device to access the data. Accordingly, by issuing a pre-read request (e.g., Read Request Command with a hint or indicator that the data is subsequently to be requested to be read) to the target device and reading data from the target device when the data is stored in the target device, the requester can avoid violating a limit on data retrievals completing within a specific number of clock cycles.

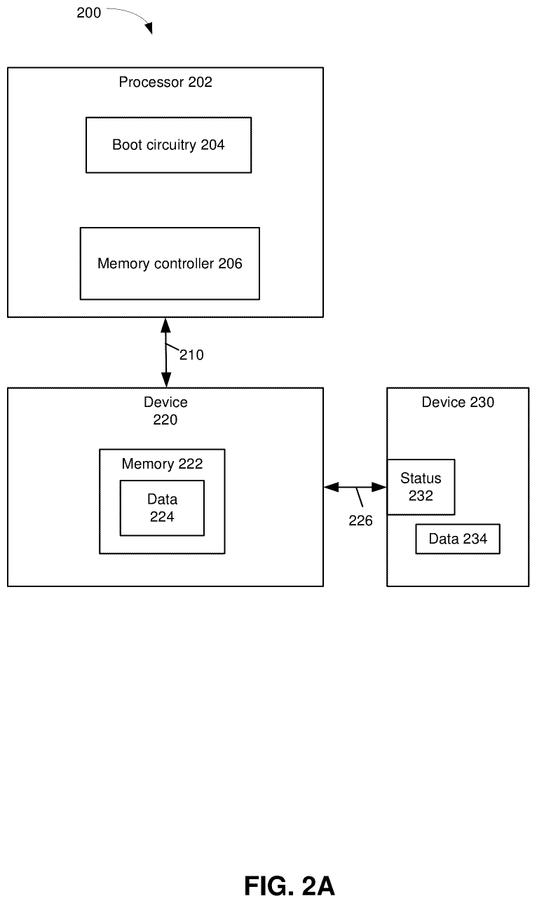

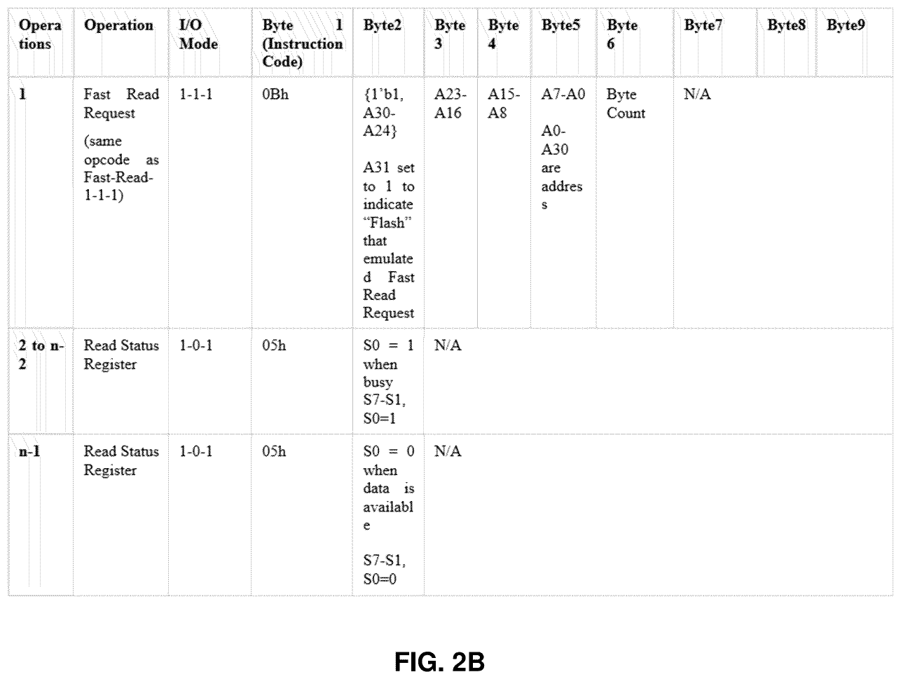

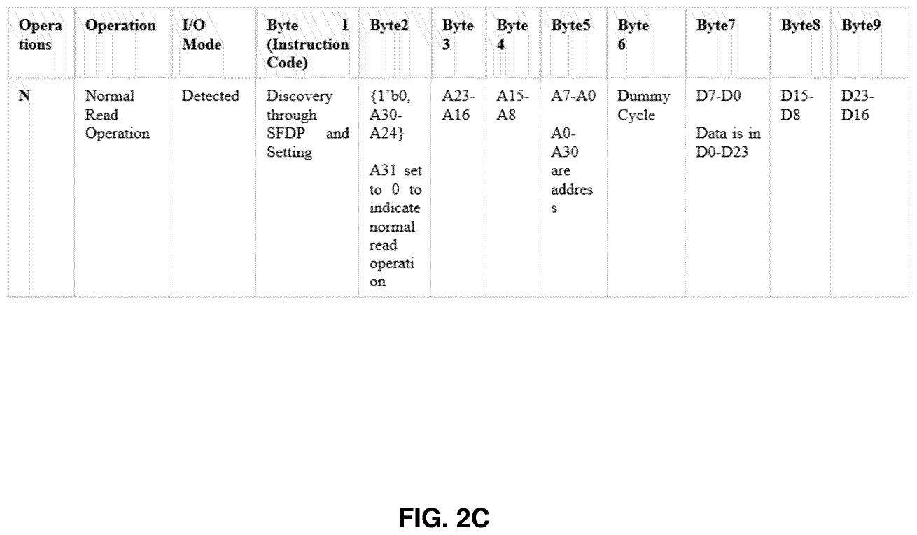

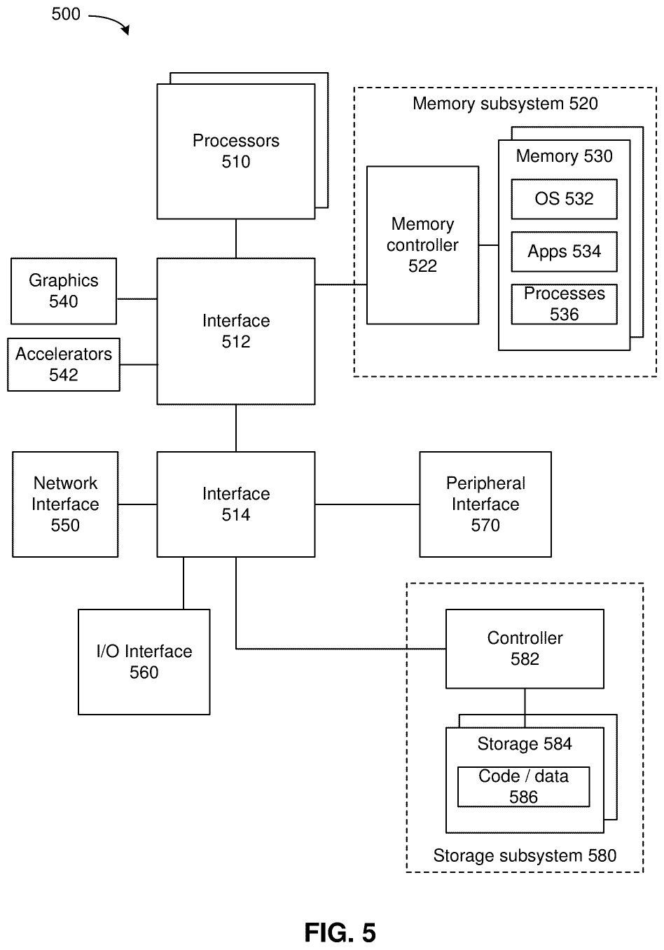

FIG. 2A depicts an example computing system 200. System 200 may include one or more processors 202 (generally referred to herein as processor 202). System 200 may include circuitry and/or software described at least with respect to FIG. 5. In some examples, processor 202 may include one or more processor cores (not shown), a cache (not shown), and/or a system agent (not shown). A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others. Any type of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A system agent can include a shared cache which may include any type of cache (e.g., level 1, level 2, or last level cache (LLC)). A system agent can include or more of: memory controller 106, a shared cache, a cache coherency manager, arithmetic logic units, floating point units, core or processor interconnects, or bus or link controllers. A system agent or uncore can provide one or more of: direct memory access (DMA) engine connection, non-cached coherent master connection, data cache coherency between cores and arbitrate cache requests, or Advanced Microcontroller Bus Architecture (AMBA) capabilities. The system agent or uncore can manage priorities and clock speeds for receive and transmit fabrics and memory controllers.

Processors 202 can access device 220 by communication through interface 210 with memory controller 206. In some examples, memory controller 206 may include circuitry (e.g., SPI controller) to control access to device 220. Interface 210 can provide communications of 1 bit, 2 bit, 4 bit, or other number of bits. Interface 210 can operate in a manner consistent with Serial Peripheral Interface (SPI), enhanced SPI (eSPI), or other type of interface (e.g., System Management Bus (SMBus), I2C, MIPI I3C®, uART, or others). For example, device 220 may include one or more of: a Non-Volatile Memory (NVM) device, flash memory, volatile memory device, cache, processor, accelerator (e.g., cryptographic, encryption, authentication, or others), network interface device, or other circuitry.

In some examples, processor 202 can read data 224 from device 220 by issuing a read request to interface 210. Data 224 can include one or more of: boot firmware, microcode (uCode), a firmware patch, digitally signed modules that contain code to be run before the x86 CPU reset vector, machine learning inference-related data, image data, packet data, packet header, or others. However, when processor 202 issues a request to device 220, but requested data 224 is not stored in memory 222 of device 220, device 220 can retrieve the requested data from device 230 (e.g., a remote disk via communications by a network interface device or virtual file system) via interface 226. Communications over interface 226 can operate in a similar manner as communications over interface 210.

Device 230 can include one or more of: a Non-Volatile Memory (NVM) device, flash memory, volatile memory device, cache, processor, accelerator (e.g., cryptographic operations, encryption, decryption, authentication, or others), network interface device, or other circuitry.

For certain read operations (e.g., read operations consistent with SPI), data 224 from device 220 is to be provided as data out to requester processor 202 within a specific number of clock cycles. However, data may not be available to be read within the specific number of clock cycles, such as where the data is retrieved from device 230 or delays caused by cryptographic operations or other accelerators operations of device 230 (e.g., compute near Flash), in addition or alternative to reading data.

FIGS. 2B and 2C show examples of a Read Flow with Wait State Support. Various examples can permit access to a target device via a SPI interface or other interface without violating SPI wait time. Operation 1 can include a Fast Read Request to signal the target device that a requester (e.g., system on chip (SoC)) is to subsequently read a certain number of bytes starting from the address specified in Bytes 2-5. The instruction can be set to 0x0Bh, which can be the same opcode as that of a SPI Fast Read 1-1-1 mode instruction. Reuse of Fast Read 1-1-1 Opcode for Fast Read Request can avoid creating a new instruction that may conflict with other existing opcode to reduce flash content corruption risk when device 220 is a SPI flash device. The Fast Read Request can distinguish from the Fast Read instruction by a value of Bit 31 in the Address field as the address Bit 31 can be set to 1, while a standard Fast Read can have Bit 31 set as 0. If a Flash device size is bounded to 2 GB, reusing address Bit 31 allows for sufficient number of bits for addresses.

The Byte 6 can be used to indicate a Byte Count Field, which allows the target device to determine the number of bytes to retrieve. Processor 202 may communicate with device 220 as an emulated SPI device and device 220 may retrieve such bytes from a remote backend device (e.g., device 230). The SPI transaction can end (e.g., clock stops and chip select number (CS #) is deselected) after device 220 retrieves the bytes from device 230.

Bit 0 of Status Register 232 can be extended from Erase/Write_In_Progress to Read/Erase/Write_In_Process. When data is not ready, device 220 can assert the Bit 0 to ‘1’. Device 220 can poll a Read Status Register 232 until Bit 0 is read as 0 or the read transaction is timed out. Where device 230 does not support the Wait State, device 230 can respond with Bit 0 as ‘0’, which indicates the data is immediately available.

In FIG. 2B, operations 2 to n-2 can determine whether the requested data is available at the target device (e.g., device 220). Device 220 can poll the Status Register Bit 0 (status 232) over interface 226 with a Read Status Register instruction (e.g., having opcode 0x05h) until a value of Status Register Bit 0 is 0 or a maximum timeout period (e.g., 10 seconds) has elapsed. If the timeout has expired, device 220 can set the completion status to abort (e.g., UR) or fill the FDATAx with FF values, and then trigger a fatal error flow or a read retry. In standard SPI flash implementations, Bit 0 in Status Register is only Set to ‘1’ when Erase and Write are in progress. However, Bit 0 value of ‘1’ is extended to cover Read in Progress so that Bit 0 is also set to ‘1’ until the data (size and start address is defined in Operation 1) is available.

Operation n−1 can occur based on Status Register Bit 0 is read as ‘0’, which indicates the data is available at device 220 and processor 202 can issue a Fast Read command to read the data in a next operation.

Referring to FIG. 2C, processor 202 can proceed to Operation N when Bit 0 is read as ‘0’. Operation N can include a Read operation, which can follow the same instruction as the case without Wait State cycle. Processor 202 can determine that the data is already available in Operation n−1 and issue a Fast Read request. Processor 202 can read data from device 220 until the number of bytes specified in Byte Count field in Operation 1 has been received. However, processor 202 may not read data that exceeds the Byte Count field in Operation 1. The Dummy Cycles can be based on the SERIAL FLASH DISCOVERABLE PARAMETERS (SFDP) table for 1-1-2, 1-1-4, 1-1-4, 1-4-4 mode as specified in JESD216 Specification (2022). In some examples, the Fast Read 1-1-1 uses a 8-Bit Dummy Cycle.

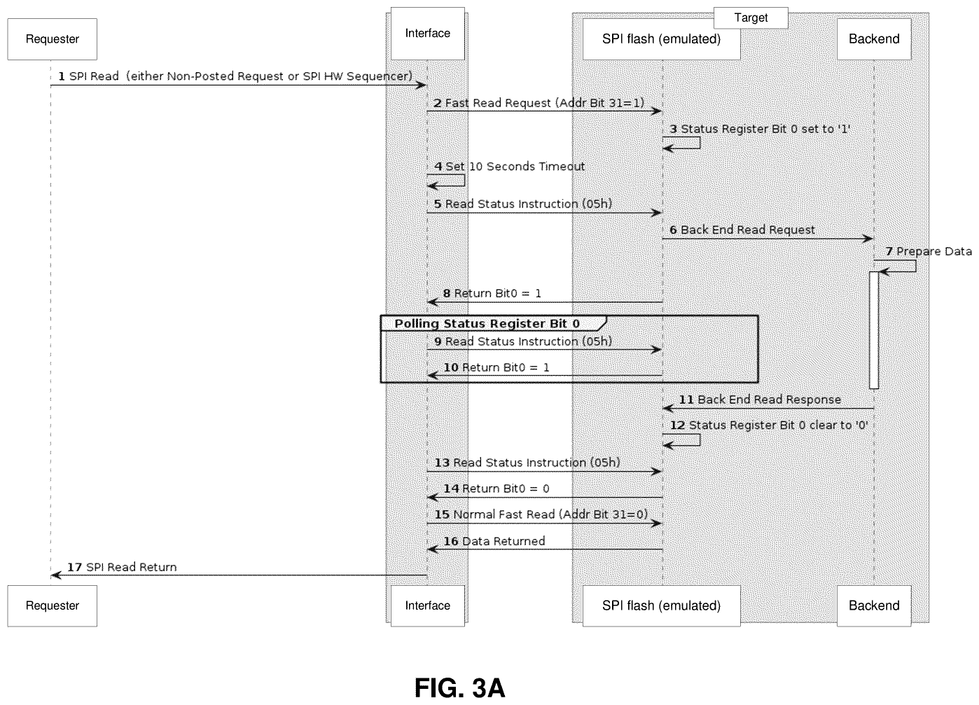

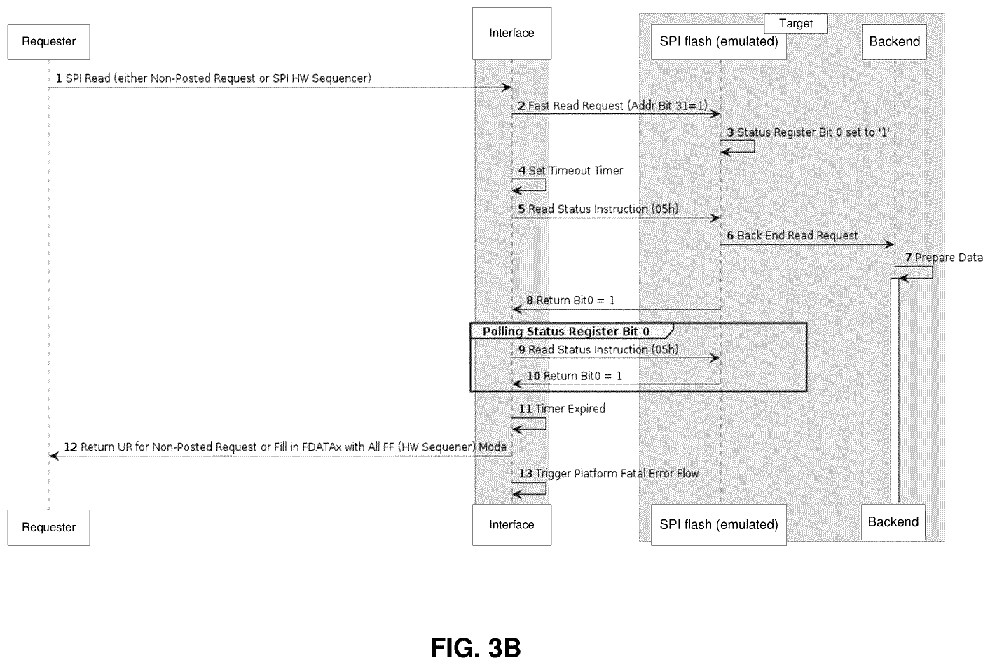

FIG. 3A depicts an example operation. The operations can be performed to access a device that is subject to a limit on time to respond to a read request. At (1), a requester (e.g., processor) can issue a SPI read (e.g., non-posted request or SPI hardware sequencer) to a memory interface device (e.g., SPI interface). At (2), the interface can determine that the requested data associated with the SPI read is stored in a separate memory device and issue a Fast Read Request with address bit 31 set to 1 to indicate that the Fast Read Request is a hint of a subsequent Fast Read Request. At (3), the memory can change a Status Register Bit 0 to ‘1’ to indicate a busy state to the interface. At (4), the interface can set a timeout counter to 10 seconds, or other value. At (5), the interface can issue at least one Read Status Instruction to read a value of Status Register Bit 0. The interface can issue at least one Read Status Instruction to read a value of Status Register Bit 0 until Bit 0 is ‘0’ or a maximum timeout period (e.g., 10 seconds) has elapsed.

At (6) and (7), the memory can retrieve data that is identified by the Fast Read Request from a backend memory device (Backend). Retrieval of data may not be a speculative pre-fetch of data because the particular data is identified. At (8), (9), and (10), Status Register Bit 0 can be set to ‘1’ to indicate the memory is busy and data is not available. At (11), the backend memory can provide a Back End Read Response to indicate data has been stored in the interface. At (12), the interface can issue at least one Read Status Instruction to read a value of Status Register Bit 0 until Bit 0 is ‘0’ or a maximum timeout period (e.g., 10 seconds or other duration) has elapsed. At (13), the interface can detect Status Register Bit 0 is a value of 1 by issuing a Read Status Instruction to read a value of Status Register Bit 0, at (14). At (15), the interface can issue a Fast Read Request with address bit 31 set to 0. At (16), the requested data can be provided to the interface to be provided to the Requester, at (17).

FIG. 3B depicts an example operation. In this example, a timeout occurs as the Wait State duration meets or exceeds a timeout duration of 10 seconds. Operations (1) to (10) are similar to those described with respect to FIG. 3A. However, at (11), as a timer has expired, interface can issue to the Requester, at (12), an error message indicating a non-posted request and/or provide one or more FF values (e.g., dummy values). Interface can handle the error by triggering a fatal error flow which can cause system reset or alter a data center administrator. Interface can handle the error by sending the request again and restarting the timer to repeat (2)-(10) as the process can potentially progress to (13) of FIG. 3A, where a request is satisfied.

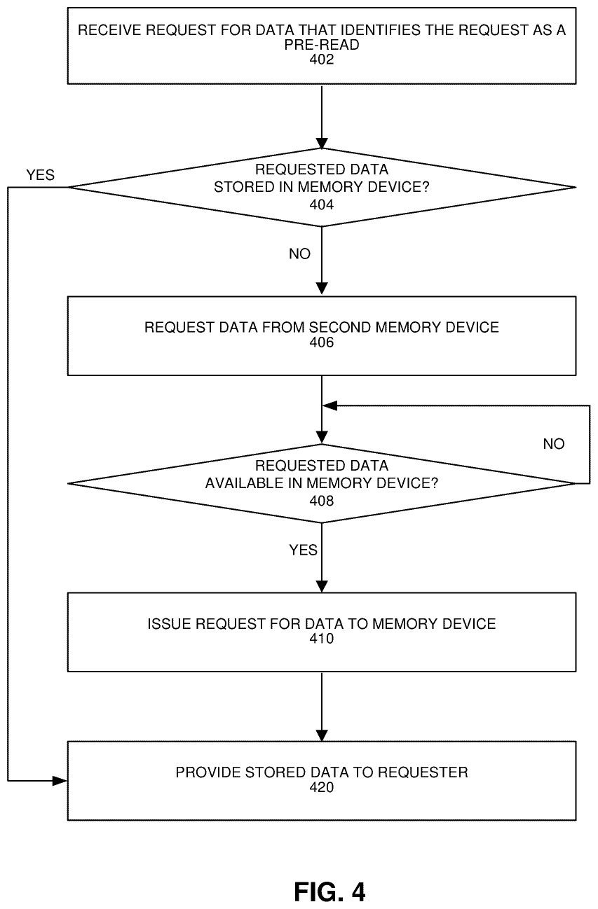

FIG. 4 depicts an example process. The process can be performed by one or more devices including at least one memory device. At 402, an interface can receive a request to read data. Communications over the interface can operate in a manner consistent with a serial or multi-bit full duplex or half duplex connection. For example, the request can include a starting address, byte count, and include an indicator that the request is a hint that a subsequent request is to be issued for the same data. For example, the indicator can be positioned in an address bit (e.g., one or more most significant bits (MSBs)).

At 404, the interface can determine whether the data is stored in memory or the data is to be retrieved from a second memory device. For example, based on the data being stored in a second memory device, the process can proceed to 406. For example, based on the data being stored in memory, the process can proceed to 420.

At 406, the interface can start a timer to complete the read of the data from the second memory device and issue a request for the data identified by the request to read data. The interface can poll for an indication the data is available to be read. At 408, based on the data being available to be read, at 410, the interface can issue a read request that includes the starting address, the byte count, and an indicator that the request is a read request and not a hint. At 420, the interface can provide the requested data to the requester via a connection.

FIG. 5 depicts a system. In some examples, circuitry of system 500 can be configured to read data within a particular time window by issuing a pre-read request to read data, followed by a read request, as described herein. System 500 includes processor 510, which provides processing, operation management, and execution of instructions for system 500. Processor 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 510 can include multiple processors and multiple processors can be embodied as processor sockets.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be a programmable or fixed function offload engine that can be accessed or used by a processor 510. For example, an accelerator among accelerators 542 can provide data compression (DC) capability, cryptography services such as public key encryption (PKE), cipher, hash/authentication capabilities, authentication, trust verification, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510. For example, memory controller 522 can be configured to adjust a size of a table indicative of locations of boot firmware and selectively permit access to the table

Applications 534 and/or processes 536 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 532 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory. Network interface 550 can receive data from a remote device, which can include storing received data into memory. In some examples, packet processing device or network interface device 550 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 500 includes one or more input/output (I/O) interface(s) 560. I/O interface 560 can include one or more interface components through which a user interacts with system 500. Peripheral interface 570 can include any hardware interface not specifically mentioned above. Peripherals refer generally to devices that connect dependently to system 500.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 500 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 500 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

An example includes circuitry connected to a processor, wherein the circuitry is to: adjust an address decode value via fuses and straps to set a decode window to an particular size. A firmware can program decoders and the boot logic to cover a programmed range.

Example 1 includes one or more examples and includes an apparatus that includes an interface to a serial connection and circuitry to: prior to issuance of a read request to a device, issue a command to the device to identify data to be requested to be read and based on an indicator that the identified data is available to be read, send the read request for the identified data via the interface to the device.

Example 2 includes one or more examples, wherein the command comprises an operational code, a starting address, and length.

Example 3 includes one or more examples, wherein the command comprises a first operational code, a starting address, and length, the read request comprises a second operational code, the starting address, and the length, and the first operational code is different than the second operational code.

Example 4 includes one or more examples, wherein the interface is to operate in a manner consistent with one or more of: Serial Peripheral Interface (SPI), Enhanced Serial Peripheral Interface (eSPI), or SMBus.

Example 5 includes one or more examples, wherein: based on receipt of a data read request from a requester, by the device, and the data not being stored in the device: the device is to request to read the identified data from a second device.

Example 6 includes one or more examples, wherein a time for the device to provide the data to the requester exceeds a dummy cycle time period limit.

Example 7 includes one or more examples, wherein the indicator that the identified data is available to be read comprises a value in a register.

Example 8 includes one or more examples, wherein the device is to enter a wait state to retrieve the data from a second device and the indicator that the identified data is available to be read comprises a de-assertion of the wait state.

Example 9 includes one or more examples, wherein the device comprises one or more of: an accelerator to perform cryptographic operations, a memory device, an accelerator to perform authentication, or an accelerator to perform trust verification.

Example 10 includes one or more examples, and includes a method that includes: based on receipt of a data read request in a device and the data not being stored in the device: issuing a command to a second device, via an interface, to identify data to be requested to be read and based on an indicator that the identified data is available to be read, sending the read request for the identified data via the interface to the device.

Example 11 includes one or more examples, wherein the command comprises an operational code, a starting address, and length.

Example 12 includes one or more examples, wherein the command comprises a first operational code, a starting address, and length, the read request comprises a second operational code, the starting address, and the length, and the first operational code is different than the second operational code.

Example 13 includes one or more examples, wherein the interface is to operate in a manner consistent with one or more of: Serial Peripheral Interface (SPI), Enhanced Serial Peripheral Interface (eSPI), or SMBus.

Example 14 includes one or more examples, wherein: based on receipt of a data read request from a requester, by the device, and the data not being stored in the device: the device is to request to read the identified data from a second device.

Example 15 includes one or more examples, wherein the indicator that the identified data is available to be read comprises a value in a register.

Example 16 includes one or more examples, and includes the device entering a wait state to retrieve the data from a second device and the device de-asserting the wait state based on the data is available to be read.

Example 17 includes one or more examples, and includes at least one non-transitory computer-readable medium comprising instructions stored thereon, that if executed by one or more processors, cause the one or more processors to: issue a request to read data from a device based on Serial Peripheral Interface (SPI) and receive the data, wherein receipt of the data occurs after exceeds an SPI dummy cycle time period limit.

Example 18 includes one or more examples, wherein based on receipt of the data read request, by the device, and the data not being stored in the device, the device is to request to read the data from a second device.

Example 19 includes one or more examples, wherein the device enters a wait state while retrieving the data from a second device and the device exits the wait state based on the data being stored in the device.

Example 20 includes one or more examples, wherein the device comprises one or more of: an accelerator or a flash memory device.

1. An apparatus comprising:
an interface to a serial connection; and
circuitry to:
prior to issuance of a read request to a device, issue a command to the device to identify data to be requested to be read and
based on an indicator that the identified data is available to be read, send the read request for the identified data via the interface to the device.

2. The apparatus of claim 1, wherein the command comprises an operational code, a starting address, and length.

3. The apparatus of claim 1, wherein
the command comprises a first operational code, a starting address, and length,
the read request comprises a second operational code, the starting address, and the length, and
the first operational code is different than the second operational code.

4. The apparatus of claim 1, wherein the interface is to operate in a manner consistent with one or more of: Serial Peripheral Interface (SPI), Enhanced Serial Peripheral Interface (eSPI), or SMBus.

5. The apparatus of claim 1, wherein:
based on receipt of a data read request from a requester, by the device, and the data not being stored in the device:
the device is to request to read the identified data from a second device.

6. The apparatus of claim 5, wherein a time for the device to provide the data to the requester exceeds a dummy cycle time period limit.

7. The apparatus of claim 1, wherein the indicator that the identified data is available to be read comprises a value in a register.

8. The apparatus of claim 1, wherein the device is to enter a wait state to retrieve the data from a second device and the indicator that the identified data is available to be read comprises a de-assertion of the wait state.

9. The apparatus of claim 1, wherein the device comprises one or more of: an accelerator to perform cryptographic operations, a memory device, an accelerator to perform authentication, or an accelerator to perform trust verification.

10. A method comprising:
based on receipt of a data read request in a device and the data not being stored in the device:
issuing a command to a second device, via an interface, to identify data to be requested to be read and
based on an indicator that the identified data is available to be read, sending the read request for the identified data via the interface to the device.

11. The method of claim 10, wherein the command comprises an operational code, a starting address, and length.

12. The method of claim 10, wherein
the command comprises a first operational code, a starting address, and length,
the read request comprises a second operational code, the starting address, and the length, and
the first operational code is different than the second operational code.

13. The method of claim 10, wherein the interface is to operate in a manner consistent with one or more of: Serial Peripheral Interface (SPI), Enhanced Serial Peripheral Interface (eSPI), or SMBus.

14. The method of claim 10, wherein:
based on receipt of a data read request from a requester, by the device, and the data not being stored in the device:
the device is to request to read the identified data from a second device.

15. The method of claim 10, wherein the indicator that the identified data is available to be read comprises a value in a register.

16. The method of claim 10, comprising:
the device entering a wait state to retrieve the data from a second device and
the device de-asserting the wait state based on the data is available to be read.

17. At least one non-transitory computer-readable medium comprising instructions stored thereon, that if executed by one or more processors, cause the one or more processors to:
issue a request to read data from a device based on Serial Peripheral Interface (SPI) and
receive the data, wherein receipt of the data occurs after exceeds an SPI dummy cycle time period limit.

18. The at least one non-transitory computer-readable medium of claim 17, wherein
based on receipt of the data read request, by the device, and the data not being stored in the device, the device is to request to read the data from a second device.

19. The at least one non-transitory computer-readable medium of claim 17, wherein
the device enters a wait state while retrieving the data from a second device and
the device exits the wait state based on the data being stored in the device.

20. The at least one non-transitory computer-readable medium of claim 17, wherein the device comprises one or more of: an accelerator or a flash memory device.
